(19) United States
(12) Patent Application Publication
(10) Pub. No.: US 2018/0260798 A1
(43) Pub. Date: Sep. 13, 2018

(54) RETRACTABLE CORD SYSTEM FOR HAND SCANNER DEVICE AT SELF CHECKOUT COUNTER

(71) Applicant: Walmart Apollo, LLC, Bentonville, AR (US)

(72) Inventor: Yurgis Mauro Bacallao, Centerton, AR (US)

(21) Appl. No.: 15/917,979

(22) Filed: Mar. 12, 2018

Related U.S. Application Data
(60) Provisional application No. 62/470,479, filed on Mar. 13, 2017.

(51) Int. Cl. G06Q 20/18; A47F 9/04; G06Q 20/20; G06K 7/10; B65H 75/48

(52) U.S. Cl. CPC G06Q 20/18; A47F 9/048; G06Q 20/208; B65H 2701/34; B65H 75/486; A47F 2009/041; G06K 2007/10524; G06K 7/10881

(57) ABSTRACT

A self checkout counter scanning apparatus comprises a handheld scanning device and a retractable cord system extending from the handheld scanning device. The retractable cord system comprises a retractable cord comprising a first end coupled to the handheld scanning device, a second end having a connector for coupling to a self checkout counter element, and a central portion between the first end and the second end. The retractable cord system further comprises a housing and a cord pulley system in the housing. The central portion of the retractable cord communicates with the cord pulley system such the first end of the retractable cord maintains a linear path from the housing to the handheld scanning device during a transition from a retraction state to an extension state of the retractable cord.

### RELATED APPLICATIONS

This application claims the benefit of U.S. Provisional Patent Application No. 62/470,479, filed Mar. 13, 2017 and entitled “Retractable Cord System for Hand Scanner Device at Self Checkout Counter,” the contents of which are incorporated herein in their entirety.

### TECHNICAL FIELD

The present inventive concepts relate generally to shopping environments and more particularly to a retractable cord system for a hand scanner device.

### BACKGROUND

Checkout counters are typically available where a customer makes payment to a retailer in exchange for items obtained while shopping at the store. A checkout counter includes a portable barcode scanning device or the like used by a store clerk to scan barcode labels on the items to itemize the obtained merchandize and calculate a price.

To improve efficiency, some retailers have installed self checkout (SCO) counters, which include an arrangement where customers can check out the items themselves through use of barcode scanners, scales, and automated payment devices. A typical SCO arrangement includes the scanning device at the end of a conveyor belt. A power cord, data cable, or the like extends from a handheld scanning device to another component of the SCO counter, such as the counter itself, a point of sale (POS) device, and so on. A typical SCO operation includes the customer placing items on one end of the conveyor, one by one, and then moving towards the other end of the conveyor, where a produce weight scale, automated payment device, or the like is located. In doing so, the conveyor sequentially carries the items towards the scanning device. However, in addition to the scanning device, an optical sensor is at the end of the conveyor belt. The sensor detects an item carried to the end portion conveyor adjacent to the scanning device, and causes the conveyor to stop moving one an item blocks the beam from the sensor indicating that the belt is full and all of the items are toward the SCO area. If the conveyor belt stops moving when it is empty, this often occurs when the sensor is being blocked by something other than a store item on the conveyor belt, such as the scanner cord loosely hanging over the conveyor belt and triggering the sensor.

### SUMMARY

In one aspect, provided is a self checkout counter scanning apparatus, comprising: a handheld scanning device; and a retractable cord system extending from the handheld scanning device. The retractable cord system comprises a retractable cord comprising: a first end coupled to the handheld scanning device; a second end having a connector for coupling to a self checkout counter element; and a central portion between the first end and the second end. The retractable cord system further comprising a housing; and a cord pulley system in the housing, wherein the central portion of the retractable cord communicates with the cord pulley system such the first end of the retractable cord maintains a linear path from the housing to the handheld scanning device during a transition from a retraction state to an extension state of the retractable cord.

In another aspect, provided is a checkout counter system, comprising: a sensor that senses objects in a line-of-sight path; a transporting element that transports objects to the line-of-sight path of the sensor; a handheld scanning device; and a retractable cord system extending from the handheld scanning device. The retractable cord system comprising a retractable cord comprising: a first end coupled to the handheld scanning device; a second end having a connector for coupling to a self checkout counter element; and a central portion between the first end and the second end. The retractable cord system further comprising a housing; and a cord pulley system in the housing, wherein the central portion of the retractable cord communicates with the cord pulley system such the first end of the retractable cord maintains a linear path from the housing to the handheld scanning device away from the line-of-sight path during a transition from a retraction state to an extension state of the retractable cord.

In another aspect, provided is a self checkout counter scanning apparatus, comprising: a handheld scanning device; and a retractable cord system extending from the handheld scanning device, the retractable cord system, comprising: a retractable cord comprising: a first end coupled to the handheld scanning device; a second end having a connector for coupling to a self checkout counter element; and a central portion between the first end and the second end; a housing; and a cord pulley system in the housing, wherein the central portion of the retractable cord communicates with the cord pulley system such the first end of the retractable cord maintains a linear path from the housing to the handheld scanning device during a transition from a retraction state to an extension state of the retractable cord, wherein a retraction of the cord prevents an sensory eye at a movable belt at the counter from being blocked and stopping the belt from moving.

In some embodiments, the retractable device advances the cord in response to a force applied to the hand scanner in a direction away from the retractable device when the hand scanner is used to scan an item.

In some embodiments, the retractable device includes an output where a first portion the cord extends linearly in a direction of extension from the output to the handle.

In some embodiments, the retractable device includes a reel or spool that rolls a second portion of the cord.

In some embodiments, the handle is unitary with the main body of the hand scanner.

In some embodiments, the cord includes two or more cables, including a data cable, a power cable, a tether or tension element, or a combination thereof.

In some embodiments, the cord pulley system comprises a spool, a first gear that drives the spool, and a second gear that drives the first gear in a first direction during cord retraction and a second direction during cord expansion.

In some embodiments, the cord pulley system further comprises a spring that drives the second gear in the first direction.

In another aspect, provided is a checkout counter system, comprising: a sensor that senses objects in a line-of-sight path; a transporting element that transports objects to the line-of-sight path of the sensor; a handheld scanning device; and a retractable cord system extending from the handheld scanning device. The retractable cord system comprises a retractable cord comprising: a first end coupled to the handheld scanning device; a second end having a connector for coupling to a self checkout counter element; and a central portion between the first end and the second end; a housing. A cord pulley system is in the housing. The central portion of the retractable cord communicates with the cord pulley system such the first end of the retractable cord maintains a linear path from the housing to the handheld scanning device away from the line-of-sight path during a transition from a retraction state to an extension state of the retractable cord, wherein a retraction of the cord prevents the sensor at a movable belt of the transporting system from being blocked and stopping the belt from moving.

In some embodiments, the retractable device advances the cord in response to a force applied to the hand scanner in a direction away from the retractable device when the hand scanner is used to scan an item.

In some embodiments, the retractable device includes an output where a first portion the cord extends linearly in a direction of extension from the output to the handle.

In some embodiments, the retractable device includes a reel or spool that rolls a second portion of the cord.

In some embodiments, the handle is unitary with the main body of the hand scanner.

In some embodiments, the cord includes two or more cables, including a data cable, a power cable, a tether or tension element, or a combination thereof.

In some embodiments, the cord pulley system comprises a spool, a first gear that drives the spool, and a second gear that drives the first gear in a first direction during cord retraction and a second direction during cord expansion.

In some embodiments, the cord pulley system further comprises a spring that drives the second gear in the first direction.

### BRIEF DESCRIPTION OF THE DRAWINGS

FIG. 1 is a diagram of a hand scanner device extending from a retractable cord, in accordance with various embodiments.

FIG. 2 is a front view with a partial cutaway of a retractable cord system shown in FIG. 1, in accordance with some embodiments.

FIG. 3A is a perspective view of a self-checkout counter at which embodiments of the present inventive concepts may be practiced.

FIG. 3B is a front view of a self-checkout counter of FIG. 3A.

FIG. 4 is a side view of a retractable cord system illustrating an interior of the retractable cord system, in accordance with some embodiments.

FIG. 5 is a front view of the interior of the retractable cord system of FIG. 4.

FIG. 6 is a view of an operation of a retractable cord system, in accordance with some embodiments.

FIG. 7 is an enlarged perspective view of a self-checkout counter including a positional relationship between a handheld scanning device and a conveyor belt sensor, in accordance with some embodiments.

### DETAILED DESCRIPTION OF EMBODIMENTS

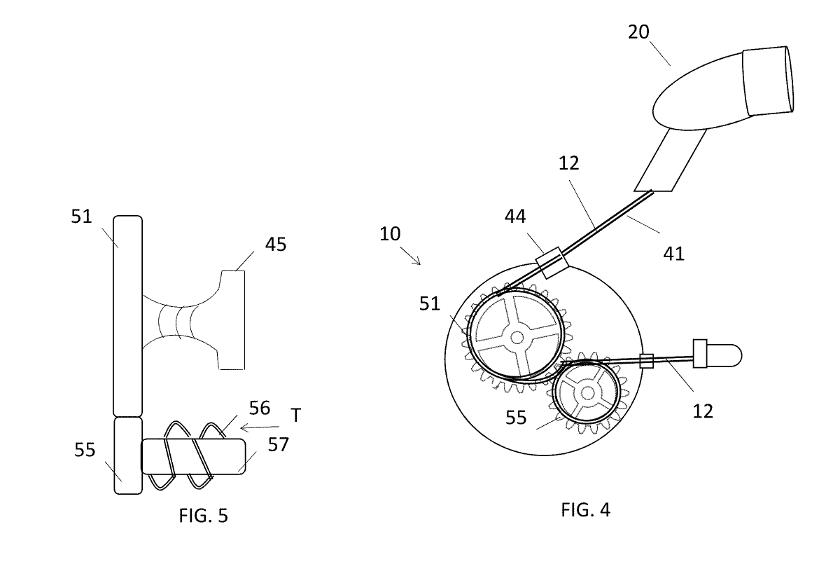

Modern handheld scanning devices such as barcode scanners or the like typically include a cord, cable, or the like that extends from the back of the scanning device to a fixed object, such as a computer enclosure, checkout counter surface, and so on. The scanning device must have some mobility in order to follow an item moving along a conveyor belt from a point where a customer places the item on the belt to an end of the conveyor belt near a weight scale, an interactive customer computer, kiosk console, or other processing component of a checkout counter. In preferred embodiments, the checkout counter is a self checkout (SCO) counter. The cord is constructed and arranged to provide for this mobility of the scanning device, for example, having a helical or spiral configuration similar to conventional telephone cables. The cord may have other utility, for example, functioning as a power cord that provides power to the scanning device, and/or a data communication cable, such as a universal serial bus (USB) cable (see FIG. 4) that exchanges electronic data signals between the scanning device and a computer on the other end of the cord. However, the cord may inadvertently be placed in front of the sensing eye of the conveyor belt sensor, which in turn sends a signal to the conveyor belt controller to stop the conveyor belt.

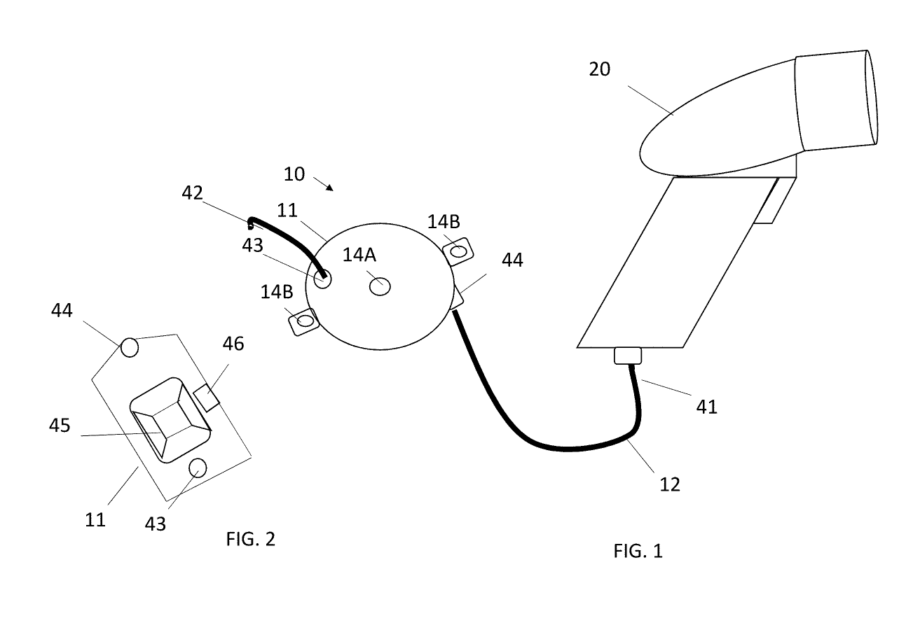

Referring to the example of FIG. 1, a cord 12 extends between a retractable cord system 10 and a handheld scanning device 20, for example, for scanning a label, barcode, QR code, or the like for identifying store merchandise. In some embodiments, the cord 12 has a different configuration than the conventional scanning device cord, in that the cord 12 does not have a helical or spiral configuration so that a portion of the cord 12 can be wrapped about a spool 45 of a retractable cord system 10.

The scanning device 20 may be a store-provided electronic scanner configured to perform a scanning function, may be used to collect data regarding the items for purchase, for example, by scanning a barcode, QR code, or the like on the item at a checkout counter. A sensor 31 detects items carried to an end portion of a conveyor belt region 30 adjacent to the scanning device 20, or at least an SCO counter from which the scanning device 20 extends. Although an optical sensor 31 is described, video cameras or the like may equally apply.

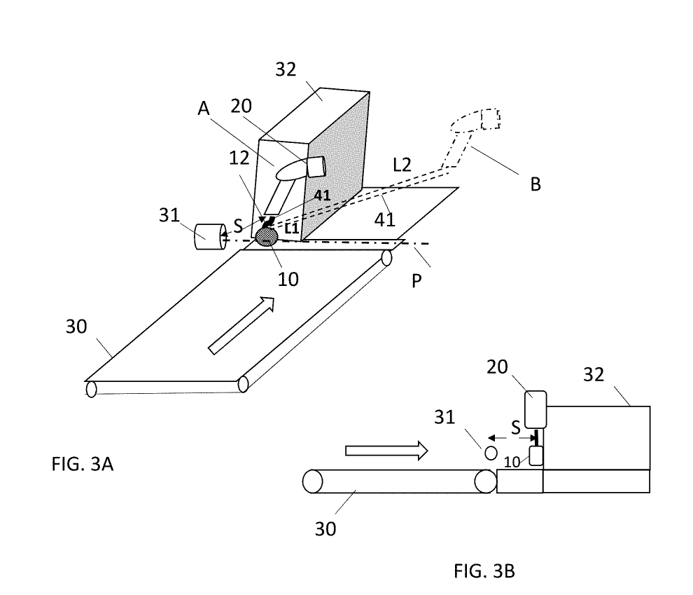

The retractable cord system 10 is constructed and arranged to prevent the scanner cord 12 from blocking the sensor eye 31 in a conveyor belt region 30 of an SCO area, shown in FIGS. 3A and 3B. To achieve this, the retractable cord system 10 includes a housing 11 for receiving the retractable cord 12 by retracting the cord 12 between the retractable cord system 10 and the scanning device 20. The housing 11 may include the spindle or spool 45 for receiving portions of the retractable cord 12, which may coil or uncoil about the spool 45 when a gear 51 to which the spool 45 is attached rotates. The spool 45 may have a curved configuration, for example, an hour-glass shape or the like so that the risk of a portion of the cord wrapped around the spool 45 slipping from the spool 45 is reduced or eliminated. The housing 11 is constructed and arranged to have a configuration suitable for housing components of a cord pulley system, including the spindle or spool 45 shown in FIG. 2, a combination of gears 51, 55 shown in FIGS. 4-6, and/or other components in accordance with some embodiments, for example, described herein. A first end 41 of the cord 12 is coupled to the scanning device 20. The first end 41 may include an adapter or other coupling device for insertion into the scanning device 20. In other embodiments, the first end 41 is hardwired, or permanently coupled to the scanning device 20, for example, including wires conductively coupled to a circuit, power source, or frame or structure of the scanning device 20. The other end 42 of the cord 12, or second end, may extend from an opening 43 in the housing 11. In some embodiments, the second end 42 remains fixed, i.e., does not move, while the first end 41 and central portion of the cord 12 extends and retracts during operation. The central portion of the cord 12 may wrap around a spool 45 (FIG. 1) in the housing 11, which rotates in response to rotation of a spool gear (shown in FIGS. 4-6). In some embodiments, the housing 11 does not include an opening 43 and the other end 42 of the cord 12 is coupled directly to a spool 45 in configurations where the cord 12 does not exchange signals, power or the like, and where the cord 12 functions exclusively as a tether, or tension cable. In some embodiments, the cord 12 includes two or more cords or cables, for example, a tether, tensioning, or “string” cord and a data cable. The two or more cords may be intertwined or otherwise coupled to each other, for example, helical configuration about each other. Alternatively, the two or more cords may be separate from each other, each rolled about the spool 45 and movement incurred via the same gears 51, 55, or movement incurred independently via different gears. In some embodiments, a single conductive cord or cable provides data, power, and tension functions.

The retractable cord system 10 may include a lock or tension control device 46 that locks or unlocks the housing 11 to hold the retractable cord 12 in place, for example, so that the reel does not apply a force to pull the cord 12 into the housing 11, or controls the amount of force on the cord 12 when the cord 12 is pulled in a direction away from the cord system 10 during expansion, for example, position B shown in FIG. 3A and/or in a direction of the cord system 10 during retraction, for example, position A.

In some embodiments, the retractable cord system 10 has a center screw support 14A, where a coupling device such as a screw is inserted through the center screw support 14A for coupling the retractable cord system 10 to a side surface of a structural portion of the SCO, such as an interactive customer computer 32, kiosk console, or the like. Accordingly, the housing 11 is held in a stationary position against the stationary SCO structure so that the cord 12 extends and retracts relative to the housing 11. In other embodiments, the retractable cord system 10 includes base side mounting holes 14B extending from the surface of the housing 11. Here, screws or other coupling devices may be inserted through the base side mounting holes 14B which extend through the housing 11 for coupling the retractable cord system 10 to a surface of a SCO component, such as an interactive customer computer 32, kiosk console, or the like. For example, the housing 11 of the retractable system 10 may be screwed into the body of a register using screws, bolts, anchoring elements, the like.

In some embodiments, the retractable cord system 10 includes a cord guide 44 to support, stabilize and guide the retractable cord 12. The cord guide 44 may include a hollow tube, which includes a lumen or other hollow passageway for receiving and directing the cord 12 to and from the interior of the housing 11. The cord guide 44 can be configured to improve advancement and retraction of the cord 12 and allow access by scanning device 20 to regions of interest at the SCO, for example, to ensure that the cord 12 does not interfere with the conveyor sensor 31.

Referring to FIGS. 4-6, retractable cord system 10 in some embodiments may include a spool gear 51 and a winding gear 55 that engage each other during a winding/unwinding operation.

The spool gear 51 rotates a spool 45, which in turn receives a portion of the cord 12 extending from the handheld scanning device 20, for example, a central portion between a first end 41 and a second end 41 of the cord 12. The spool 45 may freely rotate about its axis for example when the cord 12 at the first end 41 is pulled away from the cord system 10, and be subject to a force applied by the winding gear 55. The spool 45 may include grooves or the like for receiving windings of the cord 12, for example, parallel groove spooling. In some embodiments, the spool 45 may have grooves of different widths, depths, or shapes for receiving multiple cables, strings, cords of varying configurations and function, for example, a USB cable and a tensioning cable collocated under the same enclosure. The spool 45 may be configured for a particular spool winding pattern, such as a level wind, index wind, taper wind, reverse taper wind, flange wind, or other winding pattern known to those of ordinary skill in the art.

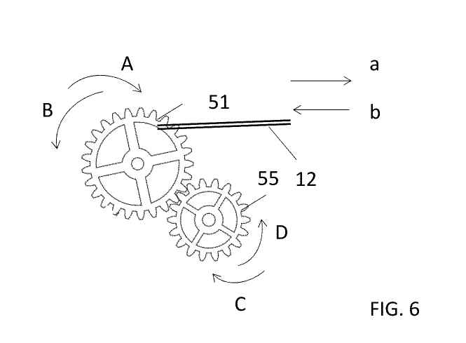

The winding gear 55 is constructed and arranged to control tension of the cord 12. In some embodiments, the winding gear 55 includes a gear spring tensioner 56 positioned about a winding tension spool 57 for controller spring tension. The gear spring tensioner 56 may include a spring or the like that generates a force, for example, provides spring tension resulting in the system 10 operating in a retraction mode. The spring member is compressed when the retractable cord 12 is outwardly extended from the housing of the housing 11. The gear spring tensioner 56 is decompressed when the retractable cord 12 is retracted into the housing 11. The winding gear 55 due to the spring tension (T) shown in FIG. 5 causes the cord 12 to retract (direction b) when no force is applied to the cord 12 in a direction away from the system 10 (shown by arrows B and C in FIG. 6). On the other hand, when the cord 12 is pulled in a direction (a) shown in FIG. 6, the gears 51, 55 rotate in directions A, D, respectively. In some embodiments, a computer processor may be configured to generate and output data signals that control the amount of tension or other force of the cord 12. Here, the tensioner 56 may operate to perform a tension-related function in response to the data signals, by converting the data signals to a mechanical adjustment.

During operation, when the cord 12 is pulled in direction (a), the winding gear 55 rotates in direction C. More specifically, when gears 51, 55 rotate in directions A and D, respectively, tension (T) is applied to the spring 56 (see FIG. 5) due to an extension or pulling of the scanning device 20 during use, causing tension to build up with respect to the spring 56. The winding gear 55 rotates in direction D, for example, counterclockwise direction, and causes unwinding of the cord 12, when the cord 12 is released, i.e., and moves in a direction (b). This in turn translates to the spool gear 51 rotating in a direction B, which in turn retracts the cord 12. The tension is released when the cord 12 is released, causing the gears to rotate in an opposite direction, i.e., directions B and C, respectively.

As shown in FIGS. 3A, 3B, and 5, the retractable cord system 10 permits a clear uninterrupted region between the conveyor sensor 31 and a side surface of a structural portion of the SCO, such as an interactive customer computer 32, kiosk console, or the like. In particular, the cord 12 is arranged by the cord system 10 so that it does not extend along an optical path, or line-of-sight path (P), of the sensor 31. This is due at least in part to the construction and orientation of the cord guide 44.

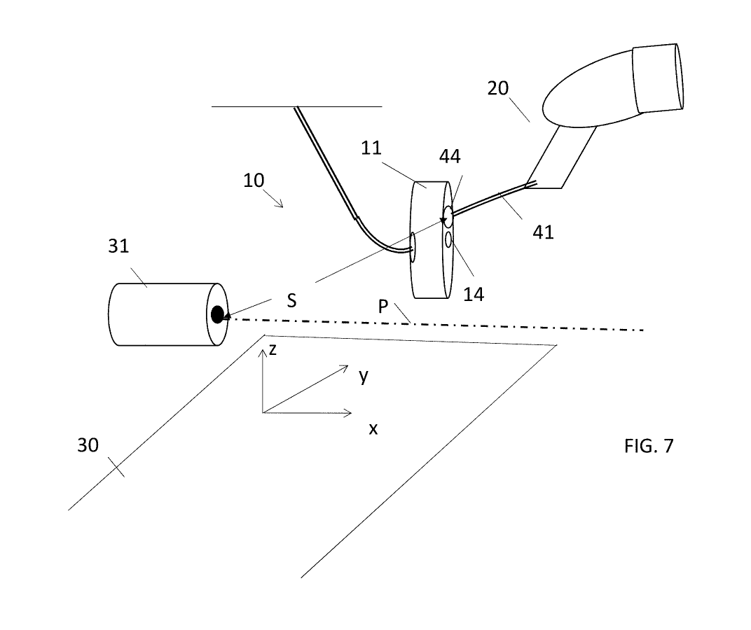

As shown in FIG. 7, in some embodiments, a conveyor belt extends along an x-y plane. A sensor 31 extends along the x axis. The optical path P of the sensor 31 is also along the x axis. The cord guide 44 is oriented in a longitudinal direction at an angle tangential to the x-z plane to maintain a separation distance S. The separation distance S extends along the y axis between the sensor eye and the cord guide 44, and serves as a buffer region whereby the cord 12 does not intersect a region of the y axis along separation distance S.

Thus, a feature of the retractable cord system 10 is that it may permit a scanning device to extend on command when pulled to scan items, for example, position B shown in FIG. 3B, and retract to its original position A when not in use. In doing so, the first end 41 of the cord 12 may have a variable length between the handheld scanning device 20 and the cord guide 44, or other input, to the housing 11. Referring again to FIG. 4, for example, the first end 41 of the cord 12 has a first length L1 when in a retracted state, and a second length L2 when in an extended state. Here, when in the extended state, the first end of the 41 maintains a linear path that does not intersect a line-of-sight path (P) of the sensor eye 31 due to a combination of the separation distance S, the maintained linear path of the first end 41 of the cord 12, and the orientation of the cord guide 44. Another feature is that the retractable cord system 10 uses current existing connections so that special construction or modification is required at the SCO counter. For example, an SCO counter may have a current configuration for a location of a side hand scanner. The retractable cord system 10 can be coupled downstream of the scanner to the connector originally receiving the cord 12 directly. The tension control device 46 is preferably configured for low tension to eliminate or reduce injury risks during operation. The construction, location, and positioning of the retractable cord system 10 at the SCO counter prevents dangling wires, e.g., cord 12, over the belt area of the conveyor 30, especially near the sensor 31.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A self checkout counter scanning apparatus, comprising:
a handheld scanning device; and
a retractable cord system extending from the handheld scanning device, the retractable cord system comprising:
a retractable cord comprising:
a first end coupled to the handheld scanning device;
a second end having a connector for coupling to a self checkout counter element; and
a central portion between the first end and the second end;
a housing; and
a cord pulley system in the housing, wherein the central portion of the retractable cord communicates with the cord pulley system such the first end of the retractable cord maintains a linear path from the housing to the handheld scanning device during a transition from a retraction state to an extension state of the retractable cord, wherein a retraction of the cord prevents a sensory eye at a movable belt at the counter from being blocked and stopping the belt from moving.

2. The self checkout counter scanning apparatus of claim 1, wherein the retractable device advances the cord in response to a force applied to the hand scanner in a direction away from the retractable device when the hand scanner is used to scan an item.

3. The self checkout counter scanning apparatus of claim 1, wherein the retractable device includes an output where a first portion the cord extends linearly in a direction of extension from the output to the handle.

4. The self checkout counter scanning apparatus of claim 3, wherein the retractable device includes a reel or spool that rolls a second portion of the cord.

5. The self checkout counter scanning apparatus of claim 1, wherein the handle is unitary with the main body of the hand scanner.

6. The self checkout counter scanning apparatus of claim 1, wherein the cord includes two or more cables, including a data cable, a power cable, a tether or tension element, or a combination thereof.

7. The self checkout counter scanning apparatus of claim 1, wherein the cord pulley system comprises a spool, a first gear that drives the spool, and a second gear that drives the first gear in a first direction during cord retraction and a second direction during cord expansion.

8. The self checkout counter scanning apparatus of claim 7, wherein the cord pulley system further comprises a spring that drives the second gear in the first direction.

9. A checkout counter system, comprising:
a sensor that senses objects in a line-of-sight path;
a transporting element that transports objects to the line-of-sight path of the sensor;
a handheld scanning device; and
a retractable cord system extending from the handheld scanning device, the retractable cord system comprising:
a retractable cord comprising:
a first end coupled to the handheld scanning device;
a second end having a connector for coupling to a self checkout counter element; and
a central portion between the first end and the second end;
a housing; and
a cord pulley system in the housing, wherein the central portion of the retractable cord communicates with the cord pulley system such the first end of the retractable cord maintains a linear path from the housing to the handheld scanning device away from the line-of-sight path during a transition from a retraction state to an extension state of the retractable cord, wherein a retraction of the cord prevents the sensor at a movable belt of the transporting system from being blocked and stopping the belt from moving.

10. The checkout counter system of claim 9, wherein the retractable device advances the cord in response to a force applied to the hand scanner in a direction away from the retractable device when the hand scanner is used to scan an item.

11. The checkout counter system of claim 9, wherein the retractable device includes an output where a first portion the cord extends linearly in a direction of extension from the output to the handle.

12. The checkout counter system of claim 11, wherein the retractable device includes a reel or spool that rolls a second portion of the cord.

13. The checkout counter system of claim 9, wherein the handle is unitary with the main body of the hand scanner.

14. The checkout counter system of claim 9, wherein the cord includes two or more cables, including a data cable, a power cable, a tether or tension element, or a combination thereof.

15. The checkout counter system of claim 9, wherein the cord pulley system comprises a spool, a first gear that drives the spool, and a second gear that drives the first gear in a first direction during cord retraction and a second direction during cord expansion.

16. The checkout counter system of claim 15, wherein the cord pulley system further comprises a spring that drives the second gear in the first direction.
